(19) United States
(12) Patent Application Publication
(10) Pub. No.: US 2026/0042869 A1
(43) Pub. Date: Feb. 12, 2026

(54) A METHOD FOR PRODUCING A THERMALLY INHIBITED STARCH

(71) Applicant: CARGILL, INCORPORATED, Wayzata, MN (US)

(72) Inventors: Dirk FONTEYN, Bonheiden (BE); Dora Chizigire NDAGANO, Waterloo (BE)

(73) Assignee: CARGILL, INCORPORATED, Wayzata, MN (US)

(21) Appl. No.: 19/100,706

(22) PCT Filed: Aug. 2, 2023
(86) PCT No.: PCT/US2023/071522

§ 371 Date: Feb. 3, 2025

(30) Foreign Application Priority Data
Aug. 8, 2022 (EP) 22189221.9

(51) Int. Cl. C08B 30/06; B01J 19/00; B01J 19/18; C08B 30/16

(52) U.S. Cl. CPC C08B 30/06; B01J 19/0013; B01J 19/0066; B01J 19/18; C08B 30/16; B01J 2219/00051; B01J 2219/00085; B01J 2219/00164; B01J 2219/00166; B01J 2219/00761

(57) ABSTRACT

The present invention relates to a method for producing a thermally inhibited starch, the method comprising providing a volume of dehydrated starch having a pH value between 7.0 and 11 and having a moisture content of <2 wt. %, based on the weight of the starch, in a stirred batch reactor, said reactor being comprised with a gas inlet, and applying a flow of gas through the volume of dehydrated starch in the reactor while heating and stirring the starch to a temperature of at least 140° C. for a period of time sufficient to thermally inhibit the starch. In addition, the invention relates to a device for thermally inhibiting starch and use of a flow of gas in a stirred batch reactor during thermal inhibition of starch.

### CROSS-REFERENCE TO RELATED APPLICATIONS

This application claims the benefit of European Application No. 22189221.9, filed Aug. 8, 2022. U.S. which is incorporated by reference herein in its entirety.

### FIELD OF THE INVENTION

The present invention relates to a method and a device for producing a thermally inhibited (TI) starch. In addition, the present invention relates to the use of a flow of a gas, preferably air, in a stirred batch reactor during thermal inhibition of starch.

### BACKGROUND OF THE INVENTION

In general, unmodified starches can be heated to below their gelatinization temperature, in water or in an aqueous solution, to ease the formation of a slurry. A starch slurry is typically made by dispersing starch in water. Upon exposing the slurry to heat, the starch contained therein becomes hydrated, it gelatinizes and swells thereby increasing the viscosity of the slurry. By heating up the starch slurry to above the gelatinization temperature, the starch is gelatinized and forms a starch paste: this gelatinization produces irreversible changes in properties such as starch granule swelling, native crystallite melting, loss of birefringence and starch solubilization. The process of slurry formation is desirable when manufacturing food applications. However, exposure of the starch to heat, shear, rapid movement, extreme pH, or other harsh conditions may cause the hydrated and swollen starch to degrade resulting in a reduction in the viscosity, which is typically undesirable.

To restrict the over-swelling and to prevent the degradation of the starch, a thermal inhibition process can be applied to the starch, to obtain a thermally inhibited starch (TI starch). Thermal inhibition causes interactions, e.g. cross-linking, between molecules in the starch, thereby allowing the resultant thermally inhibited starch to have an increase resistance to heat, shear, and/or high/low pH conditions. Thermal inhibition allows the optimal swelling of the starch to achieve the appropriate prolonged viscosity profile without over-swelling the starch, which would lead to a breakdown in the viscosity profile. In addition, thermal inhibition is a clean process since no undesirable chemicals are necessary to inhibit the starch.

Thermal inhibition is often carried out in fluidized bed reactors, for example as disclosed in EP1038882A1, stating that superior thermally inhibited starches can be obtained in shorter times in the fluidized bed reactor rather than using other conventional heating ovens. However, these type of reactors are more expensive than the commonly used stirred batch reactors. Stirred batch reactors are already present in most plants manufacturing TI starches: however, fluidization by mechanical means (stirring) in these reactors is often only possible at low loading capacities. In addition, at higher loading capacities, stirred batch reactors may require longer reaction times to achieve an acceptable level of thermal inhibition.

The present invention aims to modify the stirred batch reactors to enable the manufacturing of excellent TI starches with high productivity.

The present inventors surprisingly discovered that thermally inhibited starches can be produced with increased efficiency while maintaining product quality. Therefore, an objective of the present invention is to provide an improved method for producing thermally inhibiting starches.

The present invention addresses these problems and provides a method for thermally treating starches with improved batch sizes and/or improved efficiency.

### SUMMARY OF THE INVENTION

The invention relates to a method for producing a thermally inhibited starch, the method comprising:
providing a volume of dehydrated starch having a pH value between 7.0 and 11 and having a moisture content of less than 2 wt. %, based on the weight of the starch, in a stirred batch reactor, said reactor containing a gas inlet for the introduction of a flow of gas therein, wherein said reactor is preferably loaded to a loading capacity of between 40% and 95% of the total reactor capacity; and
introducing gas through said gas inlet to create a flow of gas and passing said flow of gas through the volume of dehydrated starch in the reactor while heating and stirring the starch to a temperature of at least 140° C., preferably to a temperature of between 15° and 170° C., for a period of time sufficient to thermally inhibit the starch.

The inventors surprisingly observed that using said flow of gas through the volume of dehydrated starch helps achieving a consistent thermal inhibition throughout the volume of the starch. In the present description with “gas” is meant a gas or mixture of gases that preferably comprise oxygen. More preferably, the gas is air.

In another aspect, the invention relates to a device for thermally inhibiting starch, the device comprising a stirred batch reactor for receiving (a volume of) starch, said reactor having a top, a bottom, side walls, heating means for heating said starch: a rotating shaft stirrer, preferably having blades or paddles, present in the batch reactor for stirring the starch in the reactor; and a gas inlet preferably located at or near the bottom of the reactor for a flow of gas through the starch, said inlet being connected to a source of gas, preferably air, more preferably compressed air.

In another aspect, the invention relates to the use of a flow of gas in a stirred batch reactor during thermal inhibition of starch wherein the flow of gas is passed through a volume of starch present in said reactor during the stirring and heating of said starch, to avoid starch decomposition. In other aspect, the invention relates to the use of a flow of oxygen-comprising gas or gas mixture (preferably air) in a stirred batch reactor during thermal inhibition of starch wherein the flow of gas is passed through a volume of starch present in said reactor during the stirring and heating of said starch, to increase the contact between the starch and the oxygen present in the flow of gas to increase the thermal inhibition efficiency.

Below in the detailed description several preferred features are disclosed. These preferred features are applicable to the method as well as to the other aspects.

### DETAILED DESCRIPTION

The present invention is elucidated below with a detailed description, with headings for each of the important features of the present invention or steps of the method. When used in this specification and claims, the terms “comprises”, “having”, and “comprising” and variations thereof mean that the specified features, steps, or integers are included. The terms are not to be interpreted to exclude the presence of other features, steps, or components. It must also be noted that as used herein and in the claims, the singular forms “a,” “an,” and “the” include plural references unless the context clearly dictates otherwise.

### Thermal Inhibition of Starch

The method of the invention relates to thermal inhibition of starch. A thermal inhibition process of a starch typically comprises the steps of: i) alkaline treatment of a starch slurry: ii) dewatering and drying the alkaline starch slurry and subsequent dehydrating the dried alkaline starch until it is anhydrous, or substantially anhydrous, preferably to less than 2 wt. % of moisture; and iii) heat-treating the dehydrated alkaline starch at a temperature and for a period of time sufficient to achieve a desired starch inhibition level. Each of these steps is discussed in detail below.

The present invention relates to a method for producing a thermally inhibited starch, the method comprising:
providing a volume of dehydrated starch having a pH value between 7.0 and 11 and having a moisture content of less than 2 wt. %, based on the weight of the starch, in a stirred batch reactor, said reactor containing a gas inlet for the introduction of a flow of gas therein, preferably wherein said reactor is loaded to a loading capacity of between 40% and 95% of the total reactor capacity; and
introducing gas through said gas inlet to create a flow of gas and passing said flow of gas through the volume of dehydrated starch in the reactor while heating and stirring the starch to a temperature of at least 140° C., preferably to a temperature of between 15° and 170° C., for a period of time sufficient to thermally inhibit the starch.

The step of providing a volume of dehydrated starch may comprise in a first aspect the following step:
loading a volume of dehydrated starch having a pH value between 7.0 and 11 and having a moisture content of <2 wt. %, based on the weight of the starch, into a stirred batch reactor, said reactor containing a gas inlet for the introduction of a flow of gas therein, preferably wherein said reactor is loaded to a loading capacity of between 40% and 95% of the total reactor capacity; and

The step of providing a volume of dehydrated starch may comprise in a second aspect the following steps:
loading a volume of dried starch having a pH value between 7.0 and 11 and having a moisture content of <14 wt. %, based on the weight of the starch, into a stirred batch reactor, said reactor containing a gas inlet for the introduction of a flow of gas therein, preferably wherein said reactor is loaded to a loading capacity of between 40% and 95% of the total reactor capacity; and
dehydrating said dried starch at a temperature of at most 120° C. for a period of time sufficient to obtain a dehydrated starch having a moisture content of <2 wt. %, based on the weight of the starch.

“Thermally inhibited starch” refers to a starch that has been obtained by a thermal inhibition process.

### i) Alkaline Treatment

In the method according to the invention a starch having a pH value between 7.0 and 11 (such as between 7.5 and 11) is loaded into a stirred batch reactor. According to the present invention, the pH of a starch is measured in a slurry of said starch as discussed below in the section “determining pH”. Such an alkaline starch can be obtained by preparing a slurry of the starch in water (e.g. city water or deionized water) and adjust the pH of said slurry between 7.0 and 11 using a base. Non-limiting examples of bases that may be used to modify the pH of the starch slurry include sodium hydroxide (NaOH), potassium hydroxide (KOH), calcium hydroxide (Ca(OH)₂), sodium carbonate (Na₂CO₃) and/or potassium carbonate (K₂CO₃).

### ii) Dehydration

In the method according to the invention a dehydrated alkaline starch having a moisture content of less than 2 wt. % based on the weight of the starch is loaded into a stirred batch reactor and subsequently thermally inhibited. Otherwise, a volume of dried alkaline starch may be loaded into a stirred batch reactor and subsequently dehydrated and thereafter thermally inhibited.

Dehydration forms an anhydrous, or essentially anhydrous, alkaline starch. In one non-limiting example of dehydrating the alkaline starch, the alkaline starch is suspended in water to form a slurry. Preferably, the slurry comprises the alkaline starch at from 30 to 40 wt. %. Alternatively, the alkaline starch may be present at a lower content (for example from 25 wt. % or lower).

In order to obtain a dehydrated alkaline starch from the alkaline starch slurry, several steps are carried out and during each step the moisture content is further reduced. In a first step, called dewatering, carried out in a centrifuge or drum filter, the alkaline starch slurry is turned into a alkaline starch cake having a moisture content of e.g. between 45 and 50 wt. %.

Subsequently, drying of the alkaline starch cake (e.g. by flash drying) may be performed at a temperature of from 65° C. to 75° C., and for a period of time sufficient until the moisture level of the alkaline starch is e.g. between 5% to 14%.

The dried alkaline starch may then be further dehydrated at a temperature of between 100° C. to 120° C., and for a time period sufficient to render the alkaline starch anhydrous or mostly anhydrous. The mostly anhydrous alkaline starch has a moisture content of: 2 weight % or less; optionally, a moisture content of 1.5 wt. % or less; optionally, a moisture content of 1 wt. % or less, based on the weight of the starch. A dehydrated starch is sensitive for moisture and if left in open air, will attract moisture. Therefore, it is preferred that directly after dehydration, the thermal inhibition step according to the invention is carried out.

iii) Heat Treatment

In the present method a heat treatment is carried on the dehydrated alkaline starch that is loaded into the reactor. The volume of dehydrated alkaline starch is heated under stirring in the reactor. Alternatively, a dried alkaline starch is loaded into the reactor and the dehydration step is carried out in the reactor prior to the thermal inhibition step. More specifically, in the present invention a flow of gas—discussed further below—is applied through the volume of dehydrated alkaline starch in the reactor while heating and stirring the starch to a temperature of at least 140° C. for a period of time sufficient to thermally inhibit the starch.

The temperature during the TI heat treatment is preferably between 150° C. and 170° C. The temperature that is meant is the temperature of the starch which is measured by a resistance thermometer that is inserted into the volume of starch.

The starch is preferably heated by heating means in the reactor such as jacketed heaters or steam heaters.

The method according to the invention may comprises an optional step of dehydrating the dried alkaline starch in the stirred batch reactor prior to starting the thermal inhibition step. Preferably this dehydration step is carried out at a temperature of maximally 120° C., such as to a temperature of between 30 and 120° C. until the moisture content is below 2 wt. %.

It is possible that the stirred batch reactor is preheated prior to the thermal inhibition step, e.g. to the temperature at which the thermal inhibition will be carried out, prior to addition of the dehydrated starch. This can for example be used when the dehydration is carried out in a different reactor. This preheating will ensure that there is minimal energy loss and that the heating of the dehydrated alkaline starch will be more effective. Preferably, the dehydrated alkaline starch is directly added to the (pre-heated) reactor after the dehydration in case the dehydration is carried out in a different reactor. The effect thereof is that the heat that is still present in the starch can be used in the heat treatment making this more energy efficient. In addition, the dehydrated starch is moisture sensitive and will attract moisture upon storage.

Typically, the period of time for TI heat treatment is from 2 and 4 hours, preferably between 2.5 and 3.5 hours.

Preferably, a starch slurry is prepared containing starch from 30 to 40 wt. % of the slurry, the balance being water. The pH of the slurry is adjusted to from 7.0 to 11.0 using any base, for example sodium carbonate. The alkaline starch slurry is then dewatered, dried and dehydrated.

Subsequently, in a preferred aspect of the invention, the dehydrated alkaline starch is heated to a temperature ranging from 140° C. to 180° C., and in some aspects from 150° C. to 170° C. for a period of time ranging from 2 and 4 hours, preferably between 2.5 and 3.5 hours while a flow of air is applied through the volume of the starch, to achieve thermal inhibition of the dehydrated alkaline starch.

### Starch Starting Material

The method of the invention relates to thermally inhibiting a dehydrated alkaline starch. With dehydrated starch is meant with a moisture content of less than 2 wt. %. Starch is a semicrystalline biopolymer made up of anhydro glucose units linked by α-(1,4) and α-(1,6) glycosidic bonds. The major components are amylose and amylopectin that differ in molecular size and degree of branching. Typically starch has a natural pH of about 4.0 to about 6.0.

The starch used in the present invention may be any starch derived from any native source, viz. a native starch. “Native starch” as used herein, is a starch as it is found in nature, for example from plants. The starch used may be any granular starch in raw or modified form. Preferably, the starch is in its raw, non-modified form, i.e. it is a native starch. Preferably, the starch is a non-pregelatinized starch. The starch is preferably a non-chemically modified starch.

The starch is preferably selected from starch from cereals, tubers and roots, legumes (including pea, chick pea, lentils, fava beans, lupin bean, and mung bean) and fruits. The starch can be corn starch, potato starch, sweet potato starch, barley starch, wheat starch, rice starch, sago starch, Kudzu starch, amaranth starch, tapioca (cassava) starch, arrowroot starch, canna starch, pea starch, banana starch, quinoa starch, oat starch, rye starch, millet starch, triticale starch and sorghum starch, as well as low amylose (waxy) and high amylose varieties thereof. “Low amylose variety” or “waxy” or “waxy variety” is intended to mean a starch containing at most 10% amylose by weight; optionally, at most 5%; optionally, at most 2%; optionally, at most 1% amylose; all by weight of the starch. Amylose-free waxy starches contain essentially 100% by weight amylopectin. “High amylose varieties” is intended to mean a starch which contains: at least 30% amylose; optionally, at least 50% amylose; optionally, at least 70% amylose; optionally, at least 80% amylose; optionally, at least 90% amylose, all by weight of the starch. The starch is more preferably selected from the group consisting of corn starch, maize starch, rice starch, potato starch, tapioca starch, wheat starch, barley starch and sorghum starch. The starch is preferably a waxy starch and more preferably selected from the group consisting of waxy corn starch, waxy maize starch, waxy rice starch, waxy potato starch, waxy tapioca starch, waxy wheat starch, waxy barley starch and waxy sorghum starch. A combination of two or more starches may also be used.

### Flow of Gas

The present invention relates to the use of a flow of gas applied through the volume of the starch while heating and stirring the starch during the thermal inhibition. With “through the volume of starch” used in the present description is meant that the gas passes through the volume of starch present in the reactor and therewith contacts the starch. Preferably, the gas is added from the side or bottom of the reactor whereafter the gas will pass through the starch and exit at the top of the reactor after having been into contact with the starch. With through the starch is not meant in the context of the application that a gas is added through the top or near the top of the reactor. The gas used is preferably air and is more preferably compressed air. The air may be dried air.

By near the bottom or the top of the reactor is herein meant a location at less than 30%, preferably less than 20% or less than 10% of the height of the reactor when measured from the bottom or the top, respectively.

When compressed air is used the pressure may be decreased from e.g. 6 bar to e.g. 1 bar by a pressure reducing valve prior to entering the reactor at the gas inlet.

The flow rate of the gas that is supplied to the reactor may be determined by the presence of a control valve that allows to regulate the flow rate: this flow rate is measured by an air flow meter present near the control valve.

The flow rate may be at least 50 m³/hour, preferably at least 150 m³/hour, more preferably at least 200 m³/hour, more preferably at least 300 m³/hour, even more preferably between 500 and 1000 m³/hour. Preferably, the flow rate is substantially constant during the flow of gas. e.g. between +/−5%. As an example, with a substantial flow rate of 150 m³/hour is meant a flow rate that is kept between 142.5 and 157.5 m³/hour, being 150 m³/hour+/−5%.

The maximum flow of gas that can be used depends on the maximum pressure that is allowable inside the reactor for safety reasons. The pressure that arises with a specific flow rate can be calculated by a person skilled in the art.

A flow of gas may be present during the whole TI heat treatment or may be present during at least 70%, at least 80%, at least 90% or at least 95% of the duration of the TI heat treatment. Preferably, the flow of gas is present during at least 95% of the duration of the TI heat treatment or during the complete heat treatment.

The temperature of the gas may be selected as desired. The gas may be as supplied at room temperature or the temperature of the flow of gas that is applied may be elevated to a temperature of between 30 and 180° C., such as between 3° and 100° C. or even to a temperature of 140° C. or 180° C. When an elevated temperature is used for the gas, the gas can be heated by a heater located in the gas feeding system, discussed below. When heated gas is used this may lead to a more homogeneous and/or faster heating of the volume of starch.

The flow of gas may be supplied to the reactor via a gas inlet. Preferably, the flow of gas is supplied through a single gas inlet. Preferably the gas inlet is positioned at or near the bottom of the reactor. With “bottom of the reactor” the reactor vessel bottom or lower side is meant. By positioning the gas inlet “at or near the bottom of the reactor”, the gas will flow (upward)—after entering the reactor—through the volume of dehydrated starch to the empty/overhead volume above the volume of starch and during this flow will have optimal (viz. maximal) contact with the starch.

The flow of gas may be an upward flow of gas through the starch. By upward flow of gas is meant of flow of gas that starts somewhere below the upper level of the volume of starch (preferably at, near, or below the lower level of the volume of starch) and will travel through the volume of starch to be released above the upper level of the volume of starch. This upward flow will ensure that there is optimal contact between the starch and the gas.

The thermal inhibition may be carried out in an oxygen enriched or an oxygen depleted atmosphere. Preferably, the oxygen concentration in the reactor is at least 4 moles/m³, such as at least 6.5 moles/m³, such as at least 9 moles/m³.

The TI starches obtained using the present invention may be bleached after their thermal inhibition. Any bleaching method can be used, typical methods including adding a bleaching agent under agitation to the TI starch.

The TI starches obtained may also be pregelatinized after their thermal inhibition. Any pregelatinized method can be used, typical methods including cooking and drying. Any known techniques may be used for pregelatinization and drying, such as drum drying, roll drying, spray drying, spray cooking, extrusion and jet cooking or combinations thereof.

The TI starch may be washed and/or dewatered and/or dried. Any washing method can be used; typical methods including adding water under agitation to the TI starch. The washing may be carried out using a (multistage) washing battery. Dewatering the slurry may comprise a step of filtering or centrifuging the TI starch, for example to a moisture level of approximately 50 wt. %. After dewatering, the starch may be dried to further reduce the moisture content thereof. Drying may include flash drying, which may be carried out until reaching a moisture level in the bleached TI starch of at least 5 wt. %, preferably of between 10 and 15 wt. %.

### Device for Carrying Out Thermal Inhibition

The device according to an aspect of the present invention comprises a stirred batch reactor, said reactor containing a rotating shaft stirrer and an inlet for gas.

### Stirred Batch Reactor

The method according to the present invention is carried out in a stirred batch reactor. This is a stirred tank reactor operated on batch basis or a Batch Stirred Tank Reactor or BSTR. Generally, these reactors are high pressure stainless steel reactors equipped with a rotating shaft for agitation of the content and generally with a heating jacket. Generally, these types of reactors are horizontal reactors. With “stirred batch reactor” in the present invention we mean a bulk type reactor that is mechanically stirred or agitated. This is to differentiate from a fluidized bed reactor (FBR) in which the particles are fluidized by a flow of gas through a multi-hole distributor plate (which leads to a plurality of streams of gas) and in which no mechanical stirrer is present.

The starch according to the present method is preferably present in the stirred batch reactor with a loading capacity of between 40% and 95% of the total reactor capacity, such as with a loading capacity of at least 50%, or at least 60% of the total reactor capacity. With “loading capacity” is meant the percentage of the total reactor volume that is filled with the starch. Each reactor has a certain volume of the reactor chamber and in addition, has a maximum loading amount (in Tons) that is specified for that reactor. For example if 4 Tons of starch are added to a reactor having a maximum specified loading capacity of 8 Tons, the loading capacity is 50%. The stirred batch reactor may comprises jacketed heaters or steam heaters to heat the starch therein.

### Rotating Shaft Stirrer

The batch reactor according to the present invention contains a rotating shaft stirrer for stirring the starch in the reactor. The rotating shaft stirrer may be of any kind but preferably has blades or paddles. The starch may for example be stirred with a stirring speed of between 5 and 30 rpm. The rotating shaft stirrer may be heated to further heat the starch (in addition to a heating jacket of the reactor).

### Inlet for Gas

The device of the present invention comprises a gas inlet located at or near the bottom of the reactor for a flow of gas through the starch. Said gas inlet is connected to a source of gas. This inlet for gas may for example be a pre-existing opening in the bottom of the reactor, e.g. for the outlet of effluent. Preferably, the flow of gas is supplied to the reactor via a single gas inlet.

The inlet may be connected to the source of gas via a gas feeding system. This gas feeding system may comprise at least one feeding line, a pressure reducing valve, a control valve and optionally an electric heater for heating said gas. The control valve may be a manual control valve that controls the supply of compressed gas.

### Parameters of the Starch

### Moisture Content

The alkaline starch that is used as starting material in the TI procedure according to the present invention may have a moisture content of less than 1.8 wt. %, preferably less than 1.6 wt. %, more preferably less than 1.4 wt. %, even more preferably less than 1.2 wt. % or even less than 1.0 wt. %.

The TI starch obtained according to the method of the present invention may have a moisture content of at least 5 wt. %, preferably between 10 and 15 wt. %.

### PH Value

The TI starch obtained according to the method of the present invention may have a pH value of at least 7.0. A lower pH value of the TI starch might result in acidic breakdown during the heating at the temperature used in the present thermal inhibition method, leading to reduced viscosity and reduced viscosity stability of the TI starch obtained, which is undesirable. Preferably, the pH of the TI starch obtained is 7.5 or higher, preferably 7.8 or higher, more preferably a pH of 8.0 or higher, even more preferably a pH of 8.2 or higher.

### Viscosity Parameters

During the thermal inhibition step, certain values for viscosity for the obtained TI starch are obtained that are desirable.

The thermally inhibited starch obtained may have a breakdown of viscosity of at most 17%, preferably at most 15%, more preferably at most 12%, even more preferably at most 10%, wherein breakdown of viscosity is defined according to equation (1):

$$breakdown = \frac{Vmax - Vhold}{Vmax} \times 100 \% \qquad Equation ( 1 )$$

wherein Vₘₐₓ is the maximum value of viscosity measured at pH 3 using a Rapid Visco Analyser after heating to 95° C.; and
wherein V_{hold} is the value of viscosity measured at pH 3 using a Rapid Visco Analyser after heating to 95° C. and holding at said temperature for 20 minutes.

A Rapid Visco Analyser (RVA) Newport scientific super 4 model may be used with the method disclosed below in the experimental section in order to measure the viscosity profiles of TI starches, as well as control starches. The viscosity at pH 3 is measured using the method below with a pH 3 buffer. In one non-limiting example of taking a viscosity measurement, the samples were suspended in a pH 3 buffer at a 5.5 wt. % dry starch content (moisture corrected).

The viscosity of the TI starch may vary widely based on the type of starch used as starting material. The degree to which a starch is thermally inhibited can be altered by varying the conditions of the thermal inhibition. The resultant TI starch is typically known as a low, medium or high thermally inhibited starch. The level of inhibition can be verified by using RVA viscosity analysis. For example, varying the level of dehydration, the method of dehydration, the conditions of the dehydration, the method of alkaline treatment, the conditions of the alkaline treatment, the pH of the alkaline treatment, the thermal inhibition temperature, the length of time the starch is thermally inhibited, rate of gas flow, gas to mass ratio, presence of inducers including starch derivatives or non-starch derivatives and other conditions of the thermal inhibition such as pressure and different gaseous environment alters the degree of thermal inhibition.

### Certain Aspects of the Invention

The invention, in an aspect, relates to a method for producing a thermally inhibited starch, the method comprising:
loading a volume of dehydrated starch having a pH value between 7.5 and 11 and having a moisture content of <2 wt. %, based on the weight of the starch, into a stirred batch reactor, said reactor containing a gas inlet for the introduction of a flow of air therein, wherein said reactor is loaded to a loading capacity of between 40% and 95% of the total reactor capacity:
introducing air through said gas inlet to create an upward flow of air having a flow rate of at least 150 m³/hour, through the volume of dehydrated starch in the reactor while heating and stirring the starch to a temperature of between 15° and 170° C., for a period of time between 2 and 4 hours to thermally inhibit the starch, wherein the thermally inhibited starch obtained has a pH of 7.0 or higher wherein the thermally inhibited starch has a viscosity breakdown of at most 17%, wherein viscosity breakdown is defined according to equation (1):

$$breakdown = \frac{Vmax - Vhold}{Vmax} \times 100 \% \qquad Equation ( 1 )$$

wherein Vₘₐₓ is the maximum value of viscosity measured at pH 3 using a Rapid Visco Analyser after heating to 95° C.; and
wherein V_{hold} is the value of viscosity measured at pH 3 using a Rapid Visco Analyser after heating to 95° C. and holding at said temperature for 20 minutes.

The invention, in another aspect, relates to a method for producing a thermally inhibited starch, the method comprising:
loading a volume of dried starch having a pH value between 7.5 and 11 and having a moisture content of <14 wt. % into a stirred batch reactor, said reactor containing a gas inlet for the introduction of a flow of air therein, wherein said reactor is loaded to a loading capacity of between 40% and 95% of the total reactor capacity:
dehydrating said dried alkaline starch at a temperature of at most 120° C. until a dehydrated alkaline starch is obtained having a moisture content of less than 2 wt. %;
introducing air through said gas inlet to create an upward flow of air having a flow rate of at least 150 m³/hour through the volume of dehydrated starch in the reactor while heating and stirring the starch to a temperature of between 15° and 170° C., for a period of time between 2 and 4 hours to thermally inhibit the starch, wherein the thermally inhibited starch obtained has a pH of 7.0 or higher wherein the thermally inhibited starch has a viscosity breakdown of at most 17%, wherein viscosity breakdown is defined according to equation (1):

$$breakdown = \frac{Vmax - Vhold}{Vmax} \times 100 \% \qquad Equation ( 1 )$$

wherein Vₘₐₓ is the maximum value of viscosity measured at pH 3 using a Rapid Visco Analyser after heating to 95° C.; and
wherein V_{hold} is the value of viscosity measured at pH 3 using a Rapid Visco Analyser after heating to 95° C. and holding at said temperature for 20 minutes.

### Uses of the TI Starch

The present invention further relates to the use of the TI starch in a food product. More particular, the present invention relates to the use of the TI starch (optionally a pregelatinized TI starch), in a food product selected from the group consisting of luxury drinks, such as coffee, black tea, powdered green tea, cocoa, adzuki-bean soup, juice, soya-bean juice, etc.; milk component-containing drinks, such as raw milk, processed milk, lactic acid beverages, etc.; a variety of drinks including nutrition-enriched drinks, such as calcium-fortified drinks and the like and dietary fibre-containing drinks, etc.; dairy products, such as butter, cheese, yoghurt, low fat yoghurt, low protein yoghurt, sour cream, coffee whitener, whipping cream, custard cream, custard pudding, etc.; iced products such as ice cream, soft cream, lacto-ice, ice milk, sherbet, frozen yoghurt, etc.; processed fat food products, such as mayonnaise, margarine, spread, shortening, etc.; soups: stews: seasonings such as sauce. TARE seasoning sauce, dressings such as Ranches dressing, dips, etc.; a variety of paste condiments represented by kneaded mustard: a variety of fillings typified by jam and flour paste: a variety or gel or paste-like food products including red bean-jam, jelly, and foods for swallowing impaired people: food products containing cereals as the main component, such as bread, noodles, pasta, pizza pie, corn flake, etc.; Japanese, US and European cakes, such as candy, cookie, biscuit, hot cake, chocolate, rice cake, etc.; kneaded marine products represented by a boiled fish cake, a fish cake, etc.; live-stock products represented by ham, sausage, hamburger steak, etc.; daily dishes such as cream croquette, paste for Chinese foods, gratin, dumpling, etc.; foods of delicate flavour, such as salted fish guts, a vegetable pickled in sake lee, etc.; liquid diets such as tube feeding liquid food, etc.; supplements; and pet foods. These food products are all encompassed within the present invention, regardless of any difference in their forms and processing operation at the time of preparation, as seen in retort foods, frozen foods, microwave foods, etc. Preferably, the TI bleached starches, optionally pregelatinized, are used in convenience applications, such as soups, sauces, and gravies, in dairy applications, such as puddings, desserts, and drinks, in bakery applications or confectionary applications, such as in fillings, in fruit applications, and in meat & fish products.

### Effects of the Invention

The use of gas, and in particular oxygen-comprising gas (such as air), in the specific manner in the specific reactor of the present invention allows for obtaining TI starches in higher batch volumes with optimal characteristics. The flow of gas allows a higher loading capacity of the stirred batch reactor. When no flow of gas is used the loading capacity is limited because otherwise undesirable side effects may take place. The present invention provides TI starches in high batch volumes that have excellent properties without the issue of undesirable side effects because of a flow of gas through the volume of dehydrated starch.

With the present invention it is possible to achieve effective thermally inhibition of starch in a stirred batch reactor while maintaining a high loading capacity. The present inventors have surprisingly found that with the method of the invention the loading capacity could be increased significantly.

The flow of gas through the starch ensures contact between the starch and the gas. Thereby, starch decomposition is avoided by the gas which at least partly displaces water that is formed during the thermal inhibition from the starch. Said water leads to starch decomposition. Moreover, by the flow of an oxygen-containing gas (mixture), such as air, through the starch, the contact between the starch and oxygen in the gas increases, which in turn increases the thermal inhibition efficiency.

Although certain aspects of the invention have been described, the scope of the appended claims is not intended to be limited solely to these specific aspects. The claims are to be construed literally, purposively, and/or to encompass equivalents. The scope of the present invention is defined by the appended claims. One or more of the objects of the invention are achieved by the appended claims.

### Materials and Methods

### Materials

Citric acid monohydrate from Fisher Chemical, 37% hydrochloric acid from Brenntag, sodium carbonate from Brenntag, 50% sodium hydroxide from Brenntag, 1.0 N sodium hydroxide from Fisher Chemical, and 0.5 N HCl from Merck.

### Determining Moisture Content

The moisture content of a sample was measured using a Sartorius MA 30 Moisture Analyser. A small amount of the sample (1.0 to 3.0 g) was weighed into the analyser. The analyser used determines the weight percentage moisture content through weight loss, and directly reports moisture content in percentage values.

### Determining RVA Viscosity

The viscosity of a sample was measured using a Newport scientific super model 4 Rapid Visco Analyser (RVA). Each sample was suspended in a buffer pH 3.0 at 5.5 wt. % sample content according to the below instructions.

### Equipment for RVA Viscosity

This method is based on the Newport Scientific Method ST-01. The RVA unit is turned on 30 minutes before use: checks should be made according to the instruction manual. An aluminum sample canister fitted with a polycarbonate paddle is used. A circulating water bath filled with demineralized water containing maximum 10% of antifreeze (e.g. ethylene glycol) is used and set to refrigerate to 10° C. A laboratory balance having a precision of 0.01 g is used to weigh the materials.

### Reagents for RVA Viscosity

Standard laboratory demineralized water is used for viscosity measurements on neutral pH. A buffer solution having pH 3.00 is used for viscosity measurements at pH 3. The buffer solution was prepared by adding 10 liters of demineralized water, 168.20 g citric acid monohydrate and 99.0 ml of 37% hydrochloric acid in a 20 liter container and mixing. Then, carefully 128.0 g of 50% sodium hydroxide was added followed by diluting to 20 liters with demineralized water and mixing. The pH should be between 2.95-3.05. If the pH was too low 1.0 N sodium hydroxide (NaOH) was added until the pH is in range. If the pH is too high 0.5 N HCl was added until the pH was in range. Otherwise a commercial buffer solution comprising citric acid, sodium hydroxide and sodium chloride may be used.

### Procedure for RVA Viscosity

First, the RVA instrument was operated with a paddle and zeroing the equipment at 160 rpm according to the instruction manual. Then, a standard calibration and adjustment procedure according to the instruction manual was carried out. The RVA was set with a temperature of 50° C. and a speed of 960 rpm at the start (time 0).

The sample was prepared by weighing 1.65 gram of the sample into the canister, and then adding either water or buffer to solution to a total weight of 30.00 g±0.02 g. The paddle was placed into the canister and the blade was jogged vigorously up and down through the suspension. Then it was ensured that any remaining sample lumps adhering to the inside of the canister are pushed down into the water. Following, the canister with sample was inserted into the RVA, and the tower is depressed to initiate the test.

After 10 seconds the speed of the RVA was decreased to 160 rpm. After 30 seconds the temperature was increased to a value of 95° C. which value was reached after 3 minutes. The temperature of 95° C. was held for 20 minutes (V_{hold}; time 23 minutes) after which within 3 minutes the temperature was brought back to 50° C. (time 26 minutes) which temperature was held for another 9 minutes after which the test was stopped (time 35 minutes). The final viscosity is the viscosity at 35 minutes. The maximum viscosity (V max) is the maximum value of the viscosity that is obtained at a temperature of 95° C., hence between 3 and 23 minutes.

### Determining pH

A pH meter was calibrated with pH 4 and pH 7 buffers. The pH was taken from starch slurry samples comprising 5 g of the sample suspended in 20 g of deionized water. The probe was inserted into the slurry, and the pH was recorded when a stable reading was achieved.

### Examples 1-5 and Comparative Examples 1-4

Thermally inhibited waxy corn starch was prepared from different size batches in a stirred batch reactor having a total reactor capacity of 8.3 kg tons. For all batches, the same alkaline waxy corn starch having a pH of 9.7 (by using sodium carbonate as a base) and dehydrated to less than 1 wt. % moisture was used.

The batch reactor was heated and thermal inhibition of the base starches was performed at a temperature of: 162° C. (comparative examples 1-3), 160° C. (comparative example 4 and examples 1-3), 165° C. (example 4), and 161° C. (example 5).

During the process of thermally inhibition, the starches were mechanically stirred using a rotating shaft stirrer with paddles/blades at 30 rpm.

For the comparative examples, no air flow was through the starch. For the examples according to the present invention, an air flow was supplied via an opening in the bottom of the reactor in a flow rate of 500 m³/hour for the examples 1-5.

During the thermal inhibition process at certain time intervals samples were taken from the reactor and these samples were analysed by RVA viscosity to ensure similar inhibition levels for i) comparative examples 1-3: ii) example 1 and comparative example 4; and iii) examples 2-5.

The different batch sizes were thermally inhibited until a predetermined thermal inhibition level. After the predetermined thermal inhibition level was reached the reactor was stopped and the pH was measured, as well as the percentage viscosity breakdown according to Equation 1 above. Table 1 below shows the reaction time needed as well as the final pH.

TABLE 1

| | | batch | loading | duration of | pH | | | viscosity |
|---|---|---|---|---|---|---|---|---|
| | | size | capacity | heat treatment | at | Vₘₐₓ | V_{hold} | breakdown |
| Run | Example | (kg tons) | (%) | (min) | end | (cP) | (cP) | (%) |
| i | Comp. 1 | 4.2 | 50.6 | 200 | 7.8 | 650 | 560 | 13.8 |
| i | Comp. 2 | 4.9 | 59.0 | 210 | 7.7 | 650 | 540 | 16.9 |
| i | Comp. 3 | 6.8 | 81.9 | 310 | 6.8 | 690 | 510 | 26.1 |
| ii | Comp. 4 | 5.4 | 66.3 | 220 | 7.4 | 610 | 495 | 18.8 |
| ii | Ex. 1 | 5.4 | 66.3 | 180 | 8.2 | 650 | 585 | 10.0 |
| iii | Ex. 2 | 5.1 | 61.4 | 195 | 8.2 | 679 | 609 | 10.3 |
| iii | Ex. 3 | 5.4 | 66.3 | 203 | 8.1 | 694 | 607 | 12.5 |
| iii | Ex. 4 | 6.1 | 73.5 | 150 | 8.1 | 677 | 594 | 12.3 |
| iii | Ex. 5 | 6.5 | 78.3 | 205 | 7.7 | 679 | 600 | 11.6 |

An increase in batch weight, resulted in longer thermal inhibition reaction times when no air is used (comparative examples 1-4). In addition, longer reaction times resulted in lower pH of the starches after sufficient thermal inhibition, even to a level of 6.8 that is undesirable, for the comparable examples. The results show that a larger batch size results in a higher breakdown percentage compared to a lower batch size when no gas is used. When applied in food processing, these thermally inhibited starches with lower viscosity stability will provide less process resistance against acid, heat, or shear in food processes and reduced viscosity contribution.

The data show that with the flow of air a decrease in duration of heat treatment is obtained, a better (higher) pH value as well as less viscosity breakdown. Therefore, one or more of the objects of the invention are achieved by the appended claims.

1. A method for producing a thermally inhibited starch, the method comprising:
providing a volume of dehydrated starch having a pH value between 7.0 and 11 and having a moisture content of <2 wt. %, based on the weight of the starch, in a stirred batch reactor, said reactor containing a gas inlet for the introduction of a flow of gas therein, preferably wherein said reactor is loaded to a loading capacity of between 40% and 95% of the total reactor capacity; and
introducing gas through said gas inlet to create a flow of gas and passing said flow of gas through the volume of dehydrated starch in the reactor while heating and stirring the starch to a temperature of at least 140° C., preferably to a temperature of between 15° and 170° C., for a period of time sufficient to thermally inhibit the starch.

2. The method according to claim 1, wherein the thermally inhibited starch has a viscosity breakdown of at most 17%, preferably at most 15%, more preferably at most 12%, even more preferably at most 10%, wherein viscosity breakdown is defined according to equation (1):
$$breakdown = \frac{Vmax - Vhold}{Vmax} \times 100 \% \qquad Equation ( 1 )$$
wherein Vₘₐₓ is the maximum value of viscosity measured at pH 3 using a Rapid Visco Analyser after heating to 95° C.; and
wherein V_{hold} is the value of viscosity measured at pH 3 using a Rapid Visco Analyser after heating to 95° C. and holding at said temperature for 20 minutes.

3. The method according to claim 1, wherein the flow of gas is an upward flow of gas through the volume of dehydrated starch.

4. The method according to claim 1, wherein the flow of gas consists of a single stream of gas.

5. The method according to claim 1, wherein the flow rate of gas that is supplied to the reactor is at least 50 m³/hour, preferably at least 150 m³/hour, preferably at least 200 m³/hour, more preferably at least 300 m³/hour, even more preferably between 500 and 1000 m³/hour.

6. The method according to claim 1, wherein a thermally inhibited starch is obtained having a pH of at least 7.0, preferably a pH of 7.5 or higher, more preferably 7.8 or higher, even more preferably a pH of 8.0 or higher, even more preferably a pH of 8.2 or higher.

7. The method according to claim 1, wherein the starch is stirred and heated for a duration of between 2 and 4 hours, preferably between 2.5 and 3.5 hours.

8. The method according to claim 1, wherein the starch is a waxy starch and/or wherein said starch is selected from the group consisting of, corn starch, maize starch, rice starch, potato starch, tapioca starch, wheat starch, barley starch and sorghum starch.

9. The method according to claim 1, wherein the reactor comprises jacketed heaters or steam heaters to heat the starch; preferably wherein the method comprises a pre-heating step of the reactor prior to addition of the starch.

10. The method according to claim 1, wherein the reactor comprises a rotating shaft stirrer, preferably having blades or paddles, to stir the starch.

11. The method according to claim 1, wherein the flow of gas is supplied to the reactor via an inlet in or near the bottom of the reactor and/or wherein compressed air is used as gas.

12. A device for thermally inhibiting starch, the device comprising:
a stirred batch reactor for receiving starch, said reactor having heating means for heating said starch;
a rotating shaft stirrer, preferably having blades or paddles, present in the batch reactor for stirring the starch in the reactor;
an inlet located at or near the bottom of the reactor for a flow of gas through the starch, said inlet is connected to a source of gas, preferably said gas being compressed air.

13. The device of claim 14, wherein the inlet is coupled to the source of gas via a gas feeding system, said gas feeding system comprising at least one feeding line, a pressure reducing valve, a control valve and optionally an electric heater for heating said gas.

14. (canceled)

15. (canceled)
